(19) United States
(12) Patent Application Publication
(10) Pub. No.: US 2026/0075153 A1
(43) Pub. Date: Mar. 12, 2026

(54) INFORMATION PROCESSING APPARATUS, INFORMATION PROCESSING METHOD, AND NON-TRANSITORY COMPUTER READABLE STORAGE MEDIUM

(71) Applicant: CANON KABUSHIKI KAISHA, Tokyo (JP)

(72) Inventor: AKIKO NAGAHARA, Kanagawa (JP)

(21) Appl. No.: 19/321,794

(22) Filed: Sep. 8, 2025

(30) Foreign Application Priority Data
Sep. 10, 2024 (JP) 2024-156500
Jun. 17, 2025 (JP) 2025-101244

(51) Int. Cl. H04N 1/00; G06V 30/26

(52) U.S. Cl. CPC H04N 1/00824; G06V 30/26; H04N 1/00384; H04N 1/0044; H04N 2201/0094

(57) ABSTRACT

Multiple character strings included in data are obtained. An input of a character is received from a user. One or more character strings corresponding to the input character are displayed on a display unit. A character string to be saved in association with a file generated based on the data is set by using a character string selected from the one or more character strings displayed.

### BACKGROUND

### Field of the Technology

The present disclosure relates to an information processing technology for assisting user input.

### Description of the Related Art

In recent years, optical character recognition (OCR) has become increasingly used for data entries involving inputting information written in paper documents to a system. However, since there are many misrecognitions in OCR results, the results input using OCR must ultimately be checked and corrected by a human. Therefore, even in the case where OCR is used, an effort at user input still remains.

Japanese Patent Laid-Open No. 2021-149531 discloses a method of extracting correction candidates for an OCR result from among correction candidates stored in advance, and displaying the extracted correction candidates in descending order of similarity calculated such that the similarity of a correction candidate is high as the characters in the correction candidate are included in a character recognition candidate for OCR. This method may reduce the effort required for the user to check and correct the OCR result.

### SUMMARY

The present disclosure includes: obtaining a plurality of character strings included in data; receiving an input of a character from a user; displaying, on a display writ, one or more character strings matching the input character among the plurality of character strings; and setting a character string to be saved in association with a file generated based on the data, by using a character string selected by the user from the one or more character strings displayed.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration example of an image processing system according to an embodiment.

FIG. 2 is a diagram illustrating a hardware configuration example of a processing terminal according to an embodiment.

FIG. 3 is a diagram illustrating a hardware configuration example of a processing terminal according to an embodiment.

FIG. 4 is a diagram illustrating a software configuration example of a processing terminal according to an embodiment.

FIGS. 5A and 5B are diagrams illustrating a configuration example of a file name input screen according to Embodiment 1.

FIG. 6 is a flowchart for explaining overall processing according to Embodiment 1.

FIG. 7 is a flowchart for explaining candidate character string creation processing according to Embodiment 1.

FIG. 8 is a specific example of a document image.

FIG. 9 is a flowchart for explaining candidate character string display processing according to Embodiment 1.

FIGS. 10A to 10C are diagrams illustrating a configuration example of a file name input screen according to Embodiment 2.

FIG. 11 is a flowchart for explaining candidate character string creation processing according to Embodiment 2.

FIG. 12 is a flowchart for explaining candidate character string display processing according to Embodiment 2.

### DESCRIPTION OF THE EMBODIMENTS

In the method in Japanese Patent Laid-Open No. 2021-149531, character strings similar to the character string in the OCR result among the character strings stored in advance as the correction candidates are displayed as correction candidates for an OCR result. On the other hand, there may be a case where a user desires to check input candidate character strings among character strings in OCR results. For example, in the case where an OCR result for an incorrectly-recognized region in image data is extracted, a user desires to input a character string using an OCR result for another region in the image data. However, the method in Japanese Patent Laid-Open No. 2021-149531 does not take into consideration the display of input candidate character strings among the character strings in OCR results.

Therefore, the present disclosure has an object to reduce the effort at user input in digitizing a document.

Hereinafter, embodiments for carrying out the present disclosure will be described by using the drawings. It should be noted that the following embodiments are not intended to limit the invention according to claims, and that all the combinations of features described in the embodiments are not necessarily essential for the solution of the invention.

### Embodiment 1

### Overall Configuration

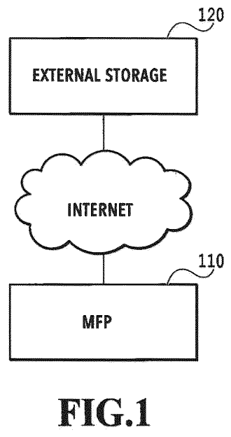

FIG. 1 illustrates an overall configuration example of an image processing system according to the present embodiment. This image processing system includes a multifunction peripheral (MFP) 110 and an external storage 120. The MFP 110 is communicably connected via a local area network (LAN) to a server that provides various services on the Internet.

The MFP 110 is a multi-function machine having multiple functions such as a scanner and a printer, and is an example of an information processing apparatus of the present disclosure. The MFP 110 also has a function of transferring scanned image data to an external service capable of storing files such as a storage service. The information processing apparatus of the present disclosure is not limited to the multi function machine having the scanner and the printer, but may be a personal computer (PC).

The external storage 120 is called a web service or a cloud service, which can store files received via the Internet and retrieve files from external apparatuses via web browsers. The number of external storages 120 is not limited to one but may be two or more.

The image processing system in the present embodiment includes the MFP 110 and the external storage 120, but the present disclosure is not limited to this configuration. For example, some of functions and processes of the MFP 110 may be implemented by another server installed on the Internet or the LAN. The external storage 120 may be installed on the LAN instead of the Internet. In addition, the external storage 120 may be replaced with an email server. In the case where an email with a scanned image attached is transmitted to the email server, the email server can store the scanned image, so the email server can be used as the external storage 120. Instead, the MFP 110 may be configured to have a storage function of the external storage 120.

### Hardware Configuration of MFP

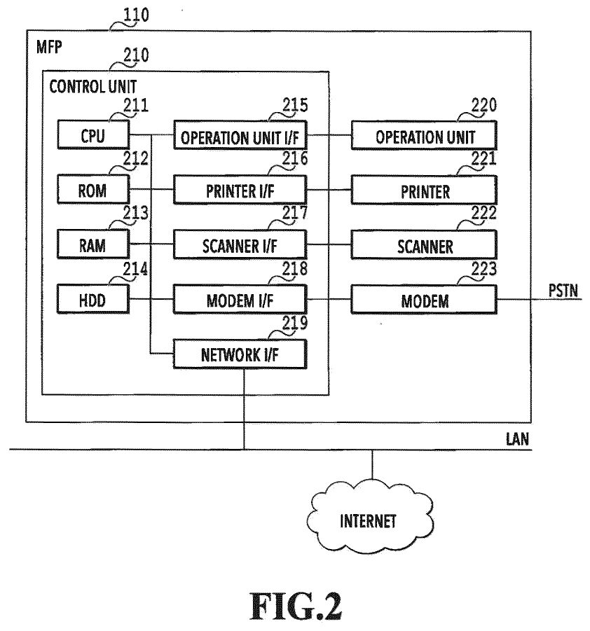

FIG. 2 illustrates a hardware configuration example of the MFP 110. The MFP 110 includes a control unit 210, an operation unit 220, a printer 221, a scanner 222, and a modem 223. The control unit 210 includes the following units 211 to 219 and controls operations of the entire MFP 110. The CPU 211 reads out a control program stored in the ROM 212 or the HDD 214, and executes and controls various functions of the MFP 110, such as reading, printing, and communication. The RAM 213 is used as temporary storage areas such as a main memory and a work area for the CPU 211. In the present embodiment, one CPU 211 executes each of processes presented in the flowcharts to be described below by using one memory (the RAM 213 or the HDD 214), but the hardware configuration is not limited to this. For example, multiple CPUs and multiple RAMs or HDDs may execute each of the processes in collaboration with each other. The HDD 214 is a large-capacity auxiliary storage configured to store image data and various programs.

The operation unit I/F 215 is an interface connecting the operation unit 220 to the control unit 210. The operation unit 220 includes a touch panel, a keyboard, and so on, and can receive operations, inputs, and instructions by a user. The printer I/F 216 is an interface connecting the printer 221 to the control unit 210. Image data for printing is transferred from the control unit 210 to the printer 221 via the printer I/F 216, and is used to make a print on a print medium. The scanner I/F 217 is an interface connecting the scanner 222 to the control unit 210. The scanner 222 generates image data by reading a document set on a platen glass or an auto document feeder (ADF) not illustrated, and inputs the image data to the control unit 210 via the scanner 1/F 217. The MFP 110 is capable of not only printing out the image data generated by the scanner 222 from the printer 221, in other words, making a copy of a document read by the scanner 222, but also transmitting the image data in a file or email format. The modem I/F 218 is an interface connecting the modem 223 to the control unit 210. The modem 223 transmits and receives image data via facsimile to and from facsimile apparatuses on the public switched telephone network (PSTN). The network 1/F 219 is an interface connecting the control unit 210, that is, the MFP 110 to the LAN. Using the network 1/F 219, the MFP 110 is capable of transmitting image data and information to and receiving various types of information from various services on the Internet.

### Hardware Configuration Example of External Storage

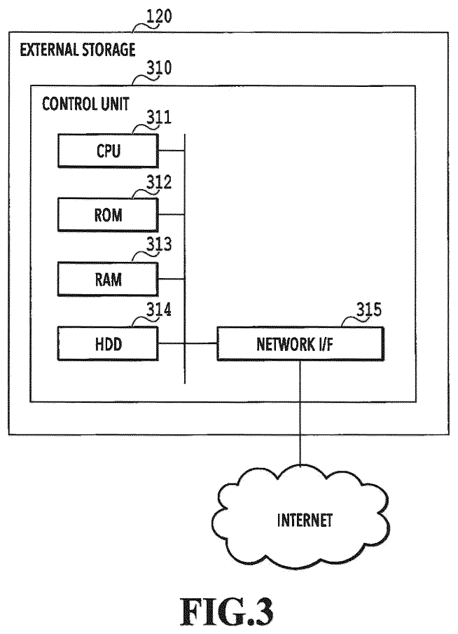

FIG. 3 illustrates a hardware configuration example of the external storage 120. The external storage 120 includes a CPU 311, a ROM 312, a RAM 313, an HDD 314, and a network 1/F 315. The CPU 311 controls operations of the entire external storage 120 by reading out a control program stored in the ROM 312 and executing various processes. The RAM 313 is used as temporary storage areas such as a main memory and a work area for the CPU 311. The HDD 314 is a large-capacity auxiliary storage configured to store image data and various programs. The network 1/F 315 is an interface connecting the external storage 120 to the Internet. The external storage 120 receives processing requests from and receives and transmits various types of information from and to external apparatuses such as the MFP 110 via the network 1/F 315.

### Software Configuration Example of MFP

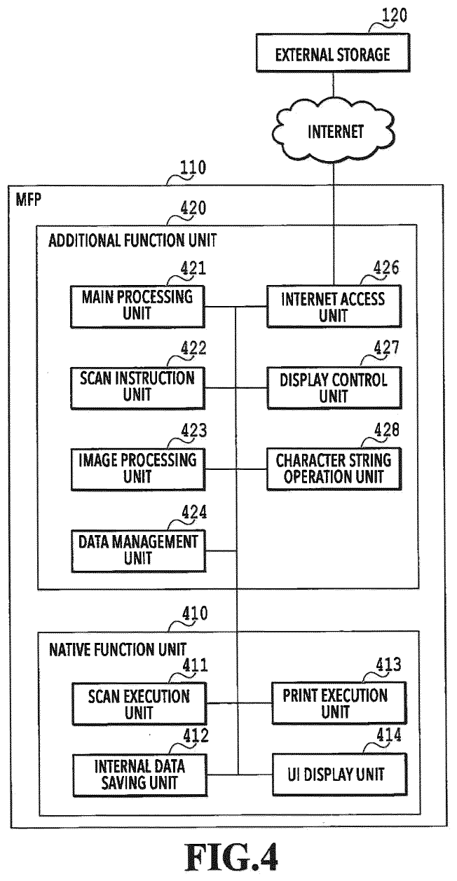

FIG. 4 illustrates a software configuration example of the image processing system according to the present embodiment. The software configuration of the MFP 110 is roughly divided into two units named a native function unit 410 and an additional function unit 420. Each of the function units is implemented by the CPU 211 reading out and executing a program stored in the ROM 212 or the HDD 214 of the MFP 110. The native function unit 410 are standard units equipped in the MFP 110, whereas the additional function unit 420 includes units additionally installed on the MFP 110. The additional function unit 420 is an application based on Java (registered trademark) and enables a function to be easily added to the MFP 110. Here, any other additional application not illustrated may be installed on the MFP 110.

The native function unit 410 includes a scan execution unit 411, an internal data saving unit 412, and a UI display unit 414. The additional function unit 420 includes a main processing unit 421, a scan instruction unit 422, an image processing unit 423, a data management unit 424, an Internet access unit 426, a display control unit 427, and a character string operation unit 428. The additional function unit 420 does not have to be built in the MFP 110 but may be implemented by a service (not illustrated) provided by an external apparatus such as a server running on the network, that is, Software as a Service (SaaS) or the like.

The main processing unit 421 has a function of controlling overall processing by the additional function unit 420 and requests each of the units included in the additional function unit 420 to execute processing.

The scan instruction unit 422 requests the scan execution unit 411 to perform scan processing according to scan settings input via a UI screen. The scan execution unit 411 receives the scan request including the scan settings from the scan instruction unit 422. In accordance with the received scan request, the scan execution unit 411 causes the scanner 222 to read a document placed on the platen glass via the scanner 1/F 217, thereby generating scanned image data. The scan execution unit 411 transmits the generated scanned image data and an image identifier for uniquely identifying that scanned image data to the internal data saving unit 412, thereby causing the scanned image data and the image identifier to be saved in the HDD 214. The scan execution unit 411 transmits the saved image identifier of the scanned image data to the scan instruction unit 422. The image identifier is a number, symbol, alphabets, or the like (not illustrated) that can be uniquely identified in the MFP 110.

The image processing unit 423 performs analysis and processing on the scanned image data. The image processing unit 423 receives the image identifier from the scan instruction unit 422, and obtains the scanned image data specified by the image identifier from the internal data saving unit 412. The image processing unit 423 performs image processing on the obtained scanned image data including character recognition processing such as character region analysis, optical character recognition (OCR), and rotation and tilt correction of an image.

The data management unit 424 holds information on the scanned image data in association with the image identifier, the information including a user input character string of a file name, OCR results, a candidate character string list, and file name information. The candidate character string list will be described in detail later. In an operation of holding a file, the data management unit 424 transmits the image identifier to the internal data saving unit 412 or the Internet access unit 426 according to output save settings in which the file name and others are set.

The Internet access unit 426 transmits a processing request to a cloud service or the like that provides a storage function (storage service). The cloud service generally releases various interfaces, based on protocols such as REST and SOAP, for saving a file in a cloud storage and retrieving a saved file by using an external apparatus. The Internet access unit 426 operates the cloud service by using the released interfaces of the cloud service. Based on the output save settings obtained from the data management unit 424, the Internet access unit 426 transmits the file obtained from the data management unit 424 to the external storage 120 via the network 1/F.

The display control unit 427 controls display of UI screens for receiving operations by the user on a liquid crystal display unit having a touch panel function of the operation unit 220 of the MFP 110. The UI screens include, for example, an operation screen for receiving a scan setting or scan start operation, a scanned image data preview operation, a file name input operation to be described later, an output setting or output start operation.

The character string operation unit 428 extracts, from the image, character strings similar to the user input character string obtained via the display control unit 427, thereby creating the candidate character string list (to be described later).

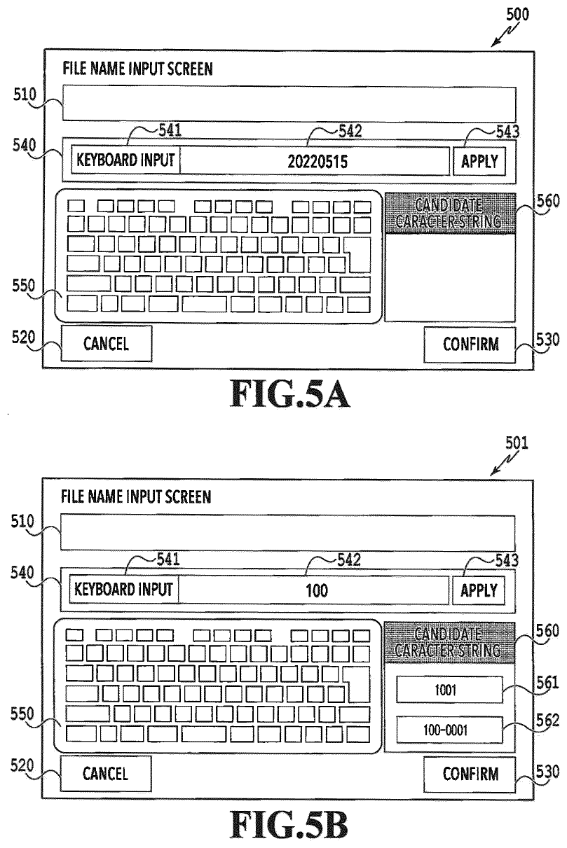

FIGS. 5A and 5B illustrate an example of file name input screens in the present embodiment for performing an input operation of a file name for scanned image data and saving the scanned image data with the input file name given. The file name input screen is a screen displayed by the operation unit 220 under control of the display control unit 427 via the UI display unit 414. Instead, this file name input screen may be output to an external apparatus by the display control unit 427 and displayed by an operation unit of the external apparatus to which the file name input screen is output.

Each of the file name input screens 500 and 501 illustrated in FIGS. 5A and 5B includes a file name display area 510, a cancel button 520, a confirmation button 530, an input character string display area 540, a software keyboard 550, a candidate character string display area 560.

The file name display area 510 is an area for displaying a determined file name. The cancel button 520 is a button for canceling a file name input operation. The confirmation button 530 is a button for confirming, as the file name, the character string displayed in the file name display area 510. The input character string display area 540 is an area for displaying a character string during input. The software keyboard 550 is a UI for receiving user input. Instead of the software keyboard 550, an input device connected via the operation unit 1/F 215 may be used to receive user input. The candidate character string display area 560 is an area for displaying a candidate character string button and a common character string button created by the character string operation unit 428. The candidate character string display area 560 may display any other buttons.

The input character string display area 540 includes an input type display area 541, a character string display area 542 for each input type, and an apply button 543 for applying the character string displayed in the character string display area 542 as the file name.

The input type display area 541 displays “KEYBOARD INPUT” in the case where the character string is input via the software keyboard 550, or displays “CANDIDATE CHARACTER STRING” in the case where a candidate character string is selected from the candidate character string display area 560. The display for identifying the input type is not limited to the above format, and the input type may be identified in another display format using icons, character colors, fonts, or the like that can be distinguished by the user.

The candidate character string display area 560 includes candidate character string buttons 561 and 562 on which candidate character strings in the candidate character string list relevant to the user input character string are displayed in a selectable manner.

FIG. 5A illustrates the file name input screen 500 in the case where the user inputs “20220515” via the software keyboard 550. In the case where the user presses the apply button 543 while the character string display area 542 displays “20220515”, the same character string as in the character string display area 542 is inserted into the file name display area 510. At this time, the character string input in the character string display area 542 is simultaneously deleted and the character string display area 542 waits for an input of a next character string. In the case where the user presses the confirmation button 530, the character string displayed in the file name display area 510 is confirmed as the file name.

In addition, an underscore or a hyphen may be set in advance as a separator between words to be used in a file name. In this setting, upon detection of the user starting a character string input operation after pressing the apply button 543, the separator is inserted in the file name display area 510, so that the file name input screen 500 gets ready to receive an input of a next character string.

FIG. 5B illustrates an input screen in the case where the user inputs “100” via the software keyboard 550 and where “No 100 (document number)” and “100-0001 (postal code)” exist in the scanned document.

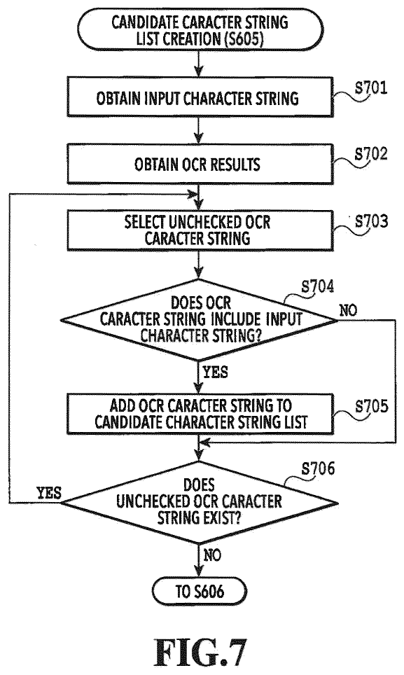

In the case where the user inputs “100” by using the software keyboard 550, the user input character string “100” is displayed in the character string display area 542. Based on the user input character string “100”, the character string operation unit 428 extracts “1001” and “100-0001” as candidate character strings from among OCR character strings recognized as candidate character strings in the scanned image data. The display control unit 427 displays the candidate character strings extracted by the character string operation unit 428 in the candidate character string display area 560. Candidate character string list creation processing will be described later in detail by using FIG. 7.

In the case where the candidate character string button 561 displayed in the candidate character string display area 560 is selected by the user, the input type display area 541 displays “CANDIDATE CHARACTER STRING” and the character string display area 542 displays the selected candidate character string “1001”. In the case where the user presses the apply button 543 in this state, the character string “1001” displayed in the file name display area 510 can be applied as the file name. In this way, the user is enabled to set a file name just by selecting an appropriate character string from among candidate character strings displayed based on the user input character string, without having to manually input the entire character string. In the case where the user uses the candidate character string, the number of user's typing operations on the software keyboard 550 can be reduced. In addition, since candidate character strings are extracted from among character strings recognized in the scanned image data, the candidate character strings which are highly likely to be used as the file name can be listed.

After the apply button 543 is pressed, the character string input to the character string display area 542 is deleted and the input type display area 541 displays “KEYBOARD INPUT” in order to wait for a next input on the software keyboard 550.

In the case where the user's character string operation is completed with pressing of the confirmation button 530, the data management unit 424 adds, as the file name, the character string displayed in the file name display area 510 to the output save settings. According to the output save settings, the data management unit 424 requests the file of the scanned image data to be saved via the internal data saving unit 412 or the Internet access unit 426.

### Overall Processing Flow

The processing to be described below is implemented by the CPU 211 of the MFP ll0 reading out a control program stored in the ROM 212 or the HDD 214 and executing and controlling the native function unit 410, the additional function unit 420, and additional programs included in the MFP 110.

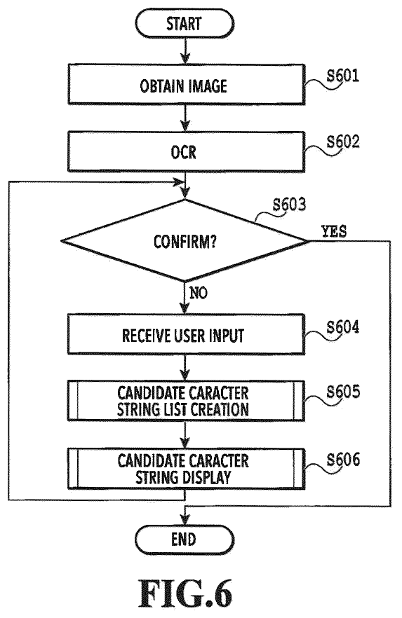

FIG. 6 presents a flowchart for explaining processing in which the MFP 110 according to the present embodiment gives a file name to scanned image data obtained by scanning and saves the scanned image data. The scanned image data is converted to a file, which is then saved in the HDD 214 or the external storage 120 serving as a cloud storage.

An application to assist a user in inputting a character string in the present disclosure (hereinafter referred to as the input assistance application) is made usable by being installed on the MFP 110. After the input assistance application is installed on the MFP 110, the functions of the input assistance application are made usable on the MFP 110.

In S601, the main processing unit 421 requests the scan execution unit 411 to scan an image via the scan instruction unit 422, obtains scanned image data generated by the scanner 222, and holds the scanned image data in the RAM 213. In the present embodiment, the main processing unit 421 obtains the scanned image data. Instead, the main processing unit 421 may request image data of the data management unit 424 and obtain the image data from the HDD 214 via the internal data saving unit 412. Alternatively, the main processing unit 421 may request image data of the data management unit 424 and obtain the image data from the external storage 120 via the Internet access unit 426. The main processing unit 421 may obtain image data by using any other means. The image data obtained by the main processing unit 421 from the HDD 214, the external storage 120, or the like may be image data other than scanned image data generated by the scanner 222.

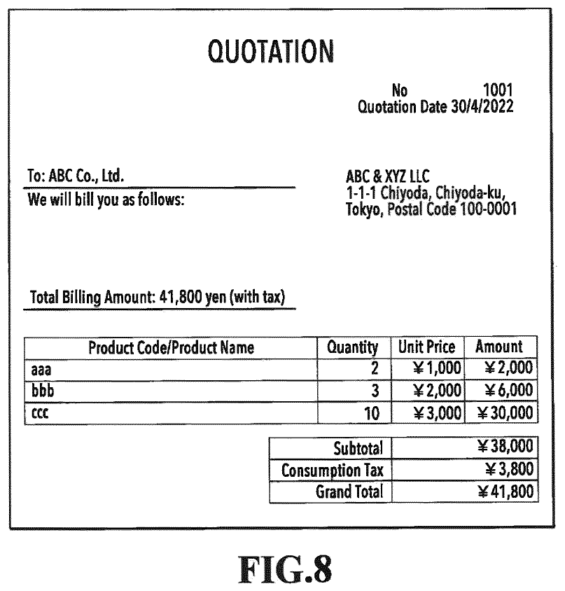

In S602, the main processing unit 421 causes the image processing unit 423 to perform OCR processing on the scanned image data obtained in S601, obtains the OCR results from the image processing unit 423, and saves the OCR results in the RAM 213. In the case where the OCR processing is performed on image data illustrated in FIG. 8, the OCR results include, for example, “QUOTATION, To, ABC Co., Ltd., No, 1001, Quotation Date, 30/4/2022, ABC & XYZ LLC, 1-1-1 Chiyoda, Chiyoda-ku, Tokyo, Postal Code, 100-0001”. In the present embodiment, the OCR results are obtained from the image processing unit 423. Instead, in the case where the OCR results are saved in the HDD 214, the OCR results may be requested of the data management unit 424 and obtained from the HDD 214 via the internal data saving unit 412. Similarly, in the case where the OCR results are saved in the external storage 120, the OCR results may be obtained from the external storage 120 via the Internet access unit 426.

In S603, the main processing unit 421 requests the display control unit 427 to cause the operation unit 220 to display the file name input screen 500, and determines whether the confirmation button 530 is pressed via the display control unit 427. If the confirmation button is pressed (YES in S603), the main processing unit 421 requests the data management unit 424 to save a file of the scanned image data using, as a file name, a character string displayed in the file name display area 510, and ends the present flow. If the confirmation button is not pressed (NO in S603), the processing proceeds to S604.

In S604, if an input operation is performed on the character string display area 542, the main processing unit 421 obtains the user input character string input to the character string display area 542 via the display control unit 427 and saves the user input character string in the RAM 213.

In S605, the main processing unit 421 requests the character string operation unit 428 to create a candidate character string list based on the OCR results obtained in S602 and the user input character string obtained in S604. The details of this step will be described later by using FIG. 7.

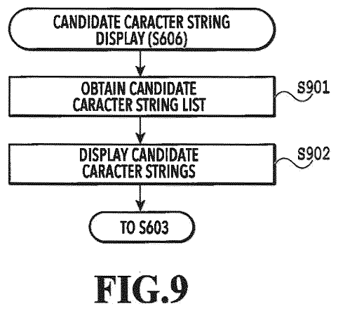

In S606, the main processing unit 421 requests the display control unit 427 to cause the operation unit 220 to display the candidate character string list created in S605 and returns to S603. The details of this step will be described later by using FIG. 9, but a case where the user desires to input “10” is described herein as an example. First, if the user does not press the confirmation button in S603 but inputs “1” to the character string display area 542, the user input is received in S604 and then S605 and S606 are performed. If the user does not press the confirmation button after returning to S603 but continuously inputs “0”, then S604, S605, and S606 are performed. Until the confirmation button is pressed in S603, S604 to S606 are performed every time the user input is updated.

FIG. 7 presents a flowchart for explaining candidate character string list creation processing in S605 in the present embodiment.

In S701, the character string operation unit 428 obtains the latest user input character string displayed in the character string display area 542 and holds the latest user input character string in the RAM 213. The latest user input character string in the present embodiment is assumed to be “100”.

In S702, the character string operation unit 428 obtains the OCR results in S602 and holds the OCR results in the RAM 213. In the case where the candidate character string list already exists in the RAM 213, the candidate character string list may be obtained, instead of the OCR results, via the data management unit 424. Since the search using the previous user input character string “10” is performed before the processing for the user input character string “100”, the candidate character string list for the user input character string “10” may be obtained. In other words, in the case where the entire user input character string used to create the candidate character string list existing in the RAM 213 is contained in the latest user input character string, the candidate character string list existing in the RAM 213 may be obtained instead of the OCR results.

In S703, the character string operation unit 428 selects one of unselected OCR character strings among OCR character strings included in the OCR results obtained in S702. The OCR character strings herein are separated by a predetermined unit with punctuation marks or spaces. The OCR character strings in the present embodiment are “QUOTATION”, “To”, “ABC Co., Ltd.”, “No”, “1001”, “Quotation Date”, “30/4/2022”, “ABC & XYZ LLC”, “1-1-1 Chiyoda, Chiyoda-ku, Tokyo”, “Postal Code”, “100-0001”, and so on. As the unit for separating the OCR character strings, a block unit in a block selection process, a morpheme, a word, a noun, or any other unit may be used.

In S704, the character string operation unit 428 compares the user input character string obtained in S701 and the OCR character string selected in S703, and determines whether the user input character string is included in the OCR character string. If the user input character string is included in the OCR character string (YES in S704), the processing proceeds to S705. If the user input character string is not included in the OCR character string (NO in S704), the processing proceeds to S706.

The determination of whether the user input character string is included in the OCR character string includes determining whether characters input by the user themselves are included in the OCR character string. This is the determination of whether characters, for example, “100” input by the user are included in the OCR character string. In the case where an OCR character string “1001” exists and where the user inputs “100”, this character string “1001” is identified as a character string including “100” and the user input character string is determined as being included in the OCR character string.

The determination of whether the user input character string is included in the OCR character string includes other types of determinations. One of them is to determine whether a character string to which a character input by the user is convertible is included in the OCR character string. In other words, this is to determine whether a character string representing a sound including a phoneme represented by a character input by the user is included in the OCR character string. For example, this is to determine whether a character string “Invoice”, to which characters “In” input by the user is convertible, is included in the OCR character string. In other words, it is a determination of whether the character string (“Invoice”) representing a sound including the phonemes represented by the characters “In” input by the user is included in the OCR character string. In the case where the OCR character string “Invoice” exists and where the user inputs “In”, this character string “Invoice” is identified as a character string including “In”, and it is determined that the user input character string is included in the OCR character string.

Regarding a type of a character string to which a character input by the user is convertible, the conversion may include not only conversion from hiragana to kanji, but also, for example, conversion from alphabet to hiragana or katakana In short, it is predictive conversion in romaji input. An input roman character is analyzed and which phoneme is represented by the input roman character is identified. For example, in the case where roman characters “re” are input, the input roman characters “re” are identified as representing the sound “re”. Then, a character string starting with this sound is identified from the OCR character strings. For example, in the case where a roman character “r” is input, “a”, “i”, “u”, “e”, “o”, “ya”, “yu”, “yo”, and so on are identified as candidates for a roman character(s) predicted to be input after the roman character “r”. Then, “ra”, “ri”, “ru”, “re”, “ro”, “rya”, “ryu”, and “ryo” are identified as sounds predicted to be input. Then, character strings starting with these sounds are identified from the OCR character strings. More specifically, the determinations may include a determination of, for example, whether a character “katakana re” to which the character “r” input by the user is convertible is included in the OCR character strings. In other words, this is a determination of whether a character (hiragana or katakana re) to which the character “r” input by the user is convertible are included in the OCR character strings. In the case where an OCR character string “receipt” exists and where the user inputs “r”, this character string “receipt” is identified as the character string including “r” and it is determined that the user input character string is included in the OCR character string. Such conversion is not limited to characters used in Japanese and English, but may be applied to characters used in other languages such as Chinese.

The OCR character strings to be used for the determination in S704 may be narrowed down to OCR character strings extracted in association with an item to which a correction target OCR character string belongs. Here, the OCR character strings in the present embodiment are extracted for each item. For example, “QUOTATION” is extracted as an OCR character string belonging to an item “Title”. In addition, “ABC Co., Ltd.” and “ABC & XYZ LLC” are extracted as OCR character strings belonging to an item “company name”. Moreover, “30/4/2022” is extracted as an OCR character string belonging to an item “date”. Then, “1001” is extracted as an OCR character string belonging to an item “quotation number”. Then, “100-0001” is extracted as an OCR character string belonging to an item “postal code”. Then, “1-1-1 Chiyoda, Chiyoda-ku, Tokyo” is extracted as an OCR character string belonging to an item “address”. The character string operation unit 428 outputs one extracted OCR character string for each item. In the case where multiple OCR character strings belonging to one item are extracted, the character string operation unit 428 may select and output one OCR character string according to a predetermined condition. For example, the OCR character string that is highly likely to belong to the item is output. For example, in the case where the user inputs “A” for the item “company name”, the OCR character string “ABC Co., Ltd.” that is highly likely to belong to the item “company name” is output. In the case where the user desires to change “ABC Co., Ltd.” to “ABC & XYZ LLC”, the user inputs “ABC &”. Then, “ABC & XYZ LLC” is displayed as the candidate character string. Here, OCR character strings to be displayed as the candidate character string may be narrowed down to OCR character strings extracted in association with the item to which the correction target OCR character string belongs. In other words, in the case where a character string including “ABC&” exists as an OCR character string belonging to another item, the character string is not displayed as the candidate character string. Since the user desires to change the OCR character string of the company name, this produces an effect of preventing the unnecessary OCR character string from being displayed.

Moreover, a rule for generating a file name may be set in advance by using the items. For example, a rule of “Title” “_(underbar)” “Company Name” is set in advance. Then, a file name is generated by using OCR character strings actually extracted. For example, a file name “QUOTATION_ABC Co., Ltd.” is generated. In the case where the user desires to change the “ABC Co., Ltd.” of this file name to “ABC & XYZ LLC”, the user inputs a character string “ABC&” via a screen for correcting an OCR character string belonging to the item “company name”. Then, in the case where the character string operation unit 428 receives the user input of “ABC &”, the character string operation unit 428 displays the OCR character string including “ABC&”, that is, “ABC & XYZ LLC” as the candidate character string.

For example, in the case where an OCR character string is “QUOTATION”, it is determined that a user input character string “100” is not included in the OCR character string. In the case where an OCR character string is “1001”, it is determined that the user input character string “100” is included in the OCR character string because the user input character string “100” matches the prefix of the OCR character string. A method of determining whether a user input character string is included in an OCR character string is not limited to prefix match but may use suffix match or partial match. In addition, character strings may be subjected to Unicode normalization before comparison between the character strings, and then compared. Moreover, in the case where a user input character string includes a character that is likely to be misrecognized in OCR, similar OCR character strings may be generated by using a similar glyph dictionary and then compared with the user input character string. The similar glyph dictionary is a database in which characters highly likely to be misrecognized in OCR processing are associated with each other. Examples of character strings highly likely to be misrecognized include “1 (number)”, “l (lowercase l)”, and “I (uppercase I)”, “0 (number)” and “o (lowercase o)”, “katakana Ya” and “small katakana ya”, and so on. Moreover, an OCR character string close to a user input character string in terms of edit distance may be determined as being included in the user input character string and treated as an inferior candidate character string.

In S705, the character string operation unit 428 adds the OCR character string determined as including the user input character string in S704 to the candidate character string list as a candidate character string, and holds the OCR character string in the RAM 213.

In S706, the character string operation unit 428 determines whether there is an unselected OCR character string in the OCR results obtained in S702. If there is an unselected OCR character string (YES in S706), the processing proceeds to S703. If there is no unselected OCR character string (NO in S706), the processing proceeds to S707.

In S707, the character string operation unit 428 requests the data management unit 424 to save the candidate character string list and ends the present flow. The data management unit 424 saves the candidate character string list in the HDD 214 via the internal data saving unit 412 or in the external storage 120 via the Internet access unit 426. In the present embodiment, the candidate character string list saved in S707 includes two candidate character strings “1001” and “100-0001”.

In the case where the candidate character string list is already created, S703 to S706 may be performed by using the candidate character strings in place of the OCR character strings. Since the number of candidate character strings is smaller than the number of OCR character strings, the processing load can be reduced.

FIG. 9 presents a flowchart for explaining candidate character string display processing in S606 in the present embodiment. In the present processing, the display control unit 427 requests the UI display unit 414 to cause the operation unit 220 to display the file name input screen 500.

In S901, the display control unit 427 requests the data management unit 424 to obtain the candidate character string list created by the character string operation unit 428 in S605, so that the candidate character string list is held in the RAM 213.

In S902, the display control unit 427 creates buttons for displaying, in the candidate character string display area 560, the respective candidate character strings included in the candidate character string list obtained in S901, and displays the created candidate character string buttons 561 and 562 in the candidate character string display area 560.

In the case where multiple candidate character strings exist and cannot be displayed all together within the candidate character string display area 560, the candidate character string display area 560 is made scrollable so that all the candidate character string buttons can be displayed. In the case of display without using scroll, the user may be informed that there are more candidate character strings than can be displayed and thereby prompted to input an additional character string, so that the candidate character strings can be narrowed down and all the candidate character string buttons can be displayed.

In addition, while a candidate character string button based on an OCR character string is displayed with a high priority given, a result of character string conversion including normal kanji conversion may also be displayed as a candidate character string button. Since there may be the case where an input character string will be used as it is, results of character string conversion include hiragana, katakana, and romaji conversion results, and also include unconverted half-width inputs of alphanumeric characters. In the case where there is not any candidate character string, a hiragana, katakana, or romaji conversion result is displayed.

In the present embodiment, as described above, character strings in a scanned image, each including a user input character string, are displayed as selectable candidate character strings, to allow the user to easily give an appropriate file name to scanned image data.

With the technology disclosed herein, the effort at user input is reduced as compared with the case where a user manually inputs all characters in a character string to be used as a file name. Even in the case where a desired character string is not displayed as a candidate character string, the user may select a candidate character string close to the desired character string and correct the selected candidate character string, so that the amount of manual character inputs by the user is reduced and a file name can be efficiently applied. In the case where a desired character string is a distinctive word, the desired character string can be identified as a candidate character string as a result of inputting only one character, which can significantly reduce the amount of character inputs. In addition, selecting candidate character strings from within a target document also produces an effect of preventing an erroneous input in typing a desired character string.

### Embodiment 2

In the case where a candidate character string is long, the candidate character string may be partly hidden or reduced in character size in order to be displayed within the candidate character string display area 560. However, such modification lowers the visibility of the candidate character string.

In the present embodiment, even in the case where a single candidate character string is a long character string, the visibility of the candidate character string is prevented from being lowered. In the description of the present embodiment, the same configurations and processing procedures as in Embodiment 1 will be omitted and only different points from Embodiment 1 will be described.

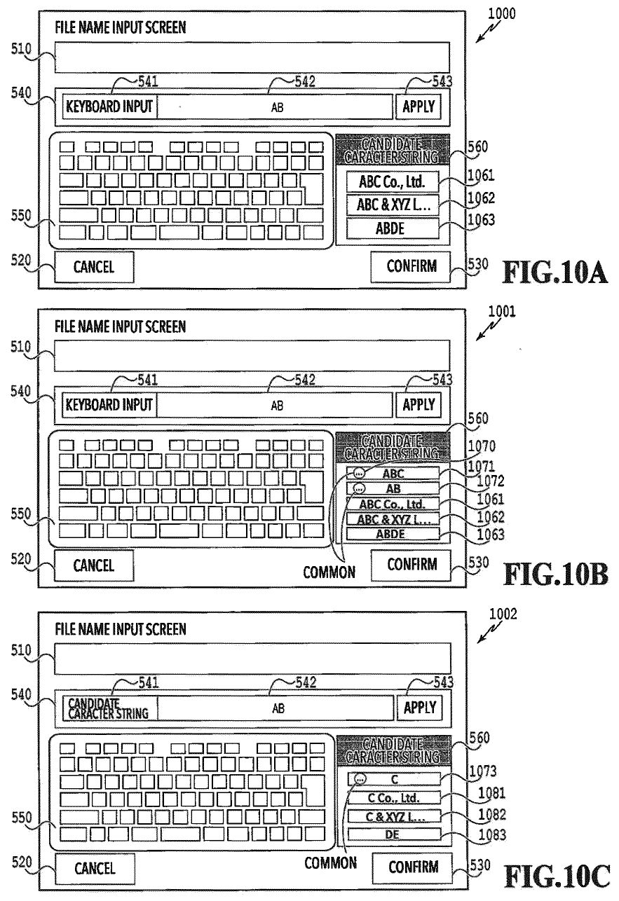

FIGS. 10A to l0C illustrate an example of file name input screens in the case where a candidate character string is a long character string. In this example, “ABDE” is assumed to exist in OCR character strings.

FIG. 10A illustrates a file name input screen 1000 displayed in the case where a user inputs “AB” via the software keyboard 550. Candidate character strings displayed at this time are “ABC Co., Ltd.”, “ABC & XYZ LLC”, and “ABDE”. In the candidate character string display area 560, the candidate character strings “ABC Co., Ltd.”, “ABC & XYZ L . . . ”, and “ABDE” are displayed on candidate character string buttons 1061, 1062, and 1063, respectively. Here, “ . . . ” in “ABC & XYZ L . . . ” displayed on the candidate character string button 1062 indicates that the candidate character string is too long and the character string that cannot be displayed follows. In the case where all the characters included in the candidate character string are not displayed as above, the user is disabled from appropriately recognizing and selecting the candidate character string. Moreover, since each of the candidate character string buttons contains the user input character string, areas for displaying different character string portions among the candidate character strings are narrowed, which makes it difficult to compare the candidate character strings. In the present embodiment, a long candidate character string is displayed in an easy-to-recognize manner.

FIG. 10B illustrates a file name input screen 1001 displayed in the case where the user inputs “AB” via the software keyboard 550, the file name input screen 1001 displaying common character string buttons. On the file name input screen 1001, “ABC” and “AB” which are character strings in common to the candidate character strings are displayed as common character strings on common character string buttons 1071 and 1072 in the candidate character string display area 560. A character string identification icon 1070 is an icon explicitly indicating a common character string, and is displayed on each of the common character string buttons 1071 and 1072.

A common character string is a character string determined as identical between the candidate character strings by the display control unit 427 as a result of comparing the candidate character strings in the candidate character string list. A conjunction character string is a character string obtained by excluding a common character string from a candidate character string. A conjunction character string list for the common character string “ABC” includes “Co., Ltd.” and “& XYZ LLC”. A conjunction character string list for the common character string “AB” includes “Co., Ltd.”, “C & XYZ LLC”, and “DE”.

Fig. l0C illustrates a file name input screen 1002 displayed in the case where the user presses the common character string button 1072 (“AB”) on the file name input screen 1001 illustrated in FIG. 10B. In the case where the common character string button 1072 is pressed, the display in the input type display area 541 is changed from “KEYBOARD INPUT” to “CANDIDATE CHARACTER STRING” which indicates that the candidate character string is selected from the candidate character string display area 560. Then, the character string “AB” displayed on the selected common character string button 1072 is displayed in the character string display area 542. In the case where the common character string button or the candidate character string button is pressed, the character string operation unit 428 holds the character string displayed on the pressed button in the RAM 213 via the data management unit 424, and displays the character string in the character string display area 542 via the display control unit 427.

Moreover, the character string operation unit 428 changes the character strings displayed on the common character string buttons and the candidate character string buttons via the display control unit 427. A candidate character string button 1081 displays a conjunction character string “C Co., Ltd.” obtained by excluding the common character string “AB” from the candidate character string “ABC Co., Ltd.”. A candidate character string button 1082 displays a conjunction character string “C & XYZ LLC” obtained by excluding the common character string “AB” from the candidate character string “ABC & XYZ LLC”. A candidate character string button 1083 displays a conjunction character string “DE” obtained by excluding the common character string “AB” from the candidate character string “ABDE”.

In addition, since “C” is a common character string for the candidate character strings “C Co., Ltd.” and “C & XYZ LLC”, a common character string button 1073 displays the common character string “C”. A conjunction character string list for the common character string “C” includes “Co., Ltd.” and “& XYZ LLC”.

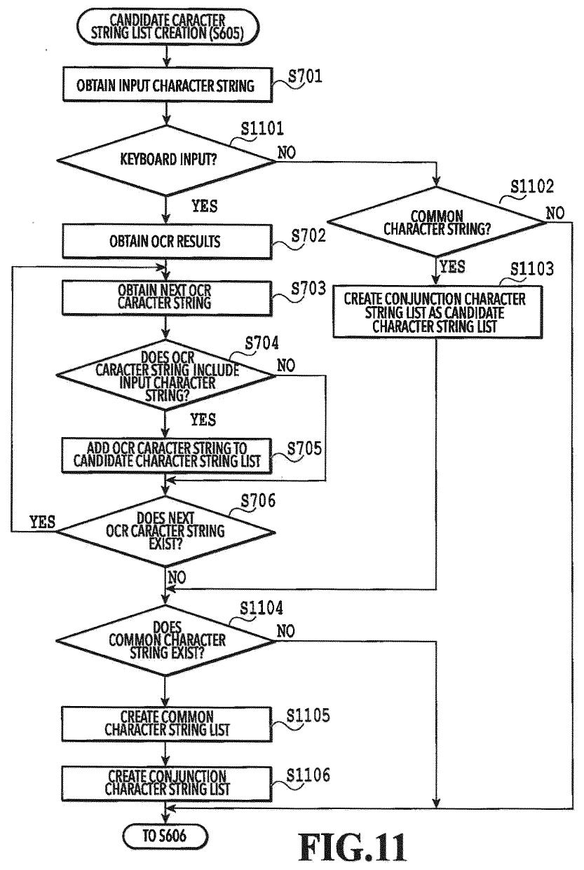

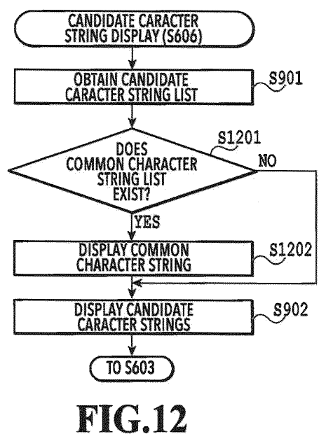

In the case where the common character string button 1073 (“C”) is pressed, the character string operation unit 428 saves the common character string “C” in addition to the common character string “AB” in the RAM 213 via the data management unit 424 and holds these two common character strings in the RAM 213. The character string display area 542 displays “ABC” which is a combination of the common character strings “AB” and “C”, which are obtained via the data management unit 424 and held in the RAM 213. Every time any button is pressed, the character string operation unit 428 additionally holds the character string displayed on the pressed button in the RAM 213 via the data management unit 424. Then, in the case where the apply button 543 is pressed, the character string operation unit 428 deletes the held data of the common character strings from the RAM 213. The details thereof will be described by using FIGS. 11 and 12.

FIG. 11 is a flowchart for explaining candidate character string list creation processing in S605 in the present embodiment. The description of the same steps as those in FIG. 7 will be omitted, and only different steps will be described.

In S1101, the character string operation unit 428 determines whether the input in S604 is a keyboard input. If the input is the keyboard input (YES in S1101), the processing proceeds to S702. If the input is not the keyboard input (the common character string or the candidate character string is selected) (NO in S1101), the processing proceeds to S1102.

In S1102, the character string operation unit 428 determines whether the common character string is selected. If the common character string is selected (YES in S1102), the processing proceeds to S1103. If the common character string is not selected (the candidate character string is selected) (NO in S1102), the present flow is ended.

In S1103, the character string operation unit 428 creates the conjunction character string list based on the conjunction character strings obtained by excluding the selected common character string from the candidate character strings including the common character string, and holds the conjunction character string list as the candidate character string list in the RAM 213. For example, in the case where the common character string button 1072 is pressed, the selected common character string “AB” and the corresponding conjunction character string list (“C Co., Ltd.”, “C & XYZ LLC”, and “DE”) are held in the RAM 213 via the data management unit 424 in association with an operation history. In the case where the common character string button 1073 is pressed, the selected common character string “C” and the corresponding conjunction character string list (“Co., Ltd.” and “& XYZ LLC”) are held in the RAM 213 in association with an operation history. The conjunction character string list will be described in S1106.

In S1104, the character string operation unit 428 compares the candidate character strings in the candidate character string list and determines whether a common character string in common to multiple candidate character strings exists. If the common character string exists (YES in S1104), the processing proceeds to S1105. If the common character string does not exist (NO in S1104), the present flow is ended.

In S1105, the character string operation unit 428 creates the common character string list and holds the common character string list in the RAM 213. In the case where the common character string “AB” is selected, the candidate character strings obtained in S1103 include the conjunction character strings for the common character string “AB”, that is, C Co., Ltd.”, “C & XYZ LLC”, and “DE”. In this case, the common character string list is created by using the first character “C” of “C Co., Ltd.” and “C & XYZ LLC” as the common character string. Instead, in the case where the common character string “ABC” is selected, the common character string list is not created because there is no common character string in the candidate character strings “Co., Ltd.” and “& XYZ LLC” in the candidate character string list.

In addition, the common character string list is created and held every time the user performs an operation. This makes it possible to display the file name input screen efficiently in the case where the user returns to the state immediately before the previous operation. Specifically, consider a case where the common character string “AB” is selected, the common character string “C” is then further selected, and the state in which “ABC” is displayed in the character string display area 542 is returned to the state before the common character string “C” is selected. In this case, the common character string list and the conjunction character string list held in the RAM 213 in association with the operation history at the time of the selection of the common character string “AB” can be obtained. As a result, the common character string list and the candidate character string list can be displayed based on the operation history without obtaining “AB” as the input character string and performing S605 again.

In the present embodiment, a common character string is defined as a prefix character string matching between multiple candidate character strings but may be defined as a suffix character string or a partial character string matching between multiple candidate character strings. In the latter case, the conjunction character string list is a list in which each “conjunction character string” in conjunction with a common character string is associated with a “conjunction position” indicating a position at which the conjunction character string is in conjunction with the common character string. In the latter case, the common character string button may display a conjunction position identification icon (not illustrated) indicating a position relative to the conjunction character string.

In S1106, the character string operation unit 428 creates the conjunction character string list for the common character string list created in S1105 and holds the conjunction character string list in the RAM 213. The character string operation unit 428 requests the data management unit 424 to save the conjunction character string list and ends the present flow.

FIG. 12 is a flowchart for explaining candidate character string display processing in S606 in the present embodiment. The description of the same steps as those in FIG. 9 will be omitted, and only different steps will be described. In the present processing, the display control unit 427 requests the UI display unit 4I 4 to cause the operation unit 220 to display the file name input screen 1000.

In S1201, the display control unit 427 determines whether the common character string list exists via the data management unit 424. If the common character string list exists (YES in Sl201), the processing proceeds to Sl202. If the common character string list does not exist (NO in S1201), the processing proceeds to S902.

In S1202, the display control unit 427 creates common character string buttons for the common character string list as many as the number of common character strings included in the common character string list, and causes the created common character string buttons to be displayed in the candidate character string display area 560 on the file name input screen 1000. After any of the common character string buttons is pressed, the candidate character string buttons display only the conjunction character strings, so that the visibility of different portions is high.

Here, in the case where no common character string exists and a candidate character string is too long to be entirely displayed within the candidate character string button, the candidate character string may be divided into words, a button may be created for each of the words, and the buttons of the respective words may be displayed in turn at multiple time points.

According to the above, it is possible to make it easy to recognize even a long candidate character string in a limited display area

In addition, the use of a common character string makes it possible to, even in the case where there are multiple candidate character strings similar to each other, easily know a difference between the candidate character strings.

Embodiments 1 and 2 employ the configuration to assist in inputting a file name of scanned image data. However, the technology in present disclosure is not limited to this. The technology in the present disclosure may be applied to inputs related to scanned image data such as inputs of a folder name of a folder for saving the scanned image data and various types of data on the scanned image data.

### Modification

Embodiments 1 and 2 are described about the case where OCR character string candidates to which a character input by a user is convertible are displayed. However, the present disclosure is not limited to this. For example, in the case where a deletion of a character from a displayed OCR character string is received from a user, an OCR character string other than the displayed OCR character string may be displayed as a candidate character string. In this case, if a deletion of some characters (for example, a single character) or all the characters from the displayed OCR character string is received from the user, an OCR character string other than the displayed OCR character string may be displayed as a candidate character string.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to reduce the effort at user input in digitizing a document.

This application claims the benefit of Japanese Patent Applications No. 2024-156500, filed Sep. 10, 2024, and No. 2025-101244 filed Jun. 17, 2025 which are hereby incorporated by reference herein in their entirety.

What is claimed is:

1. An information processing apparatus comprising:
a controller including a processor and a memory, the controller configured to:
obtain a plurality of character strings included in data;
receive an input of a character from a user;
display, on a display unit, one or more character strings corresponding to the input character among the plurality of character strings; and
set a character string to be saved in association with a file generated based on the data, by using a character string selected by the user from the one or more character strings displayed.

2. The information processing apparatus according to claim 1, wherein the character string to be saved in association with the file is a name of the file.

3. The information processing apparatus according to claim 1, wherein a common character sting in common to the one or more character strings is displayed on the display unit.

4. The information processing apparatus according to claim 3, wherein
in a case where the user selects the common character string displayed on the display unit, one or more character strings obtained by excluding the selected common character string from the one or more character strings including the common character string are displayed on the display unit.

5. The information processing apparatus according to claim 1, wherein the input of the character is received based on a keyboard input.

6. The information processing apparatus according to claim 1, wherein
the plurality of character stings included in the data are a plurality of character strings recognized in the data through character recognition processing on the data, and
a character string including the input character and included in the plurality of character strings recognized through the character recognition processing is displayed on the display unit.

7. The information processing apparatus according to claim 6, wherein
the input character is replaced with a character with a similar glyph, and
a character string including the character with the similar glyph and included in the plurality of character strings recognized through the character recognition processing is displayed on the display unit.

8. The information processing apparatus according to claim 6, wherein the plurality of character strings recognized through the character recognition processing include a plurality of character strings obtained by dividing a character string included in the data by a predetermined unit.

9. The information processing apparatus according to claim 1, wherein the data is image data obtained by scanning a document with a scanner.

10. The information processing apparatus according to claim 9, wherein the information processing apparatus is an image forming apparatus having the scanner.

11. The information processing apparatus according to claim 1, wherein the one or more character strings corresponding to the input character are one or more character strings each including the input character among the plurality of character strings.

12. The information processing apparatus according to claim 1, wherein the one or more character strings corresponding to the input character are one or more character strings each including a character to which the input character is convertible among the plurality of character strings.

13. The information processing apparatus according to claim 1, wherein
a setting of an item to be used to generate the character string to be saved in association with the file is received, and
one or more character strings belonging to the item are identified among the plurality of character strings,
wherein the input of the character is received in association with the item, and
wherein the one or more character strings are one or more character strings corresponding to the character among the one or more character strings belonging to the item.

14. An information processing method, comprising:
obtaining a plurality of character strings included in data;
receiving an input of a character from a user;
displaying, on a display unit, one or more character strings corresponding to the input character among the plurality of character strings; and
setting a character string to be saved in association with a file generated based on the data, by using a character string selected by the user from the one or more character strings displayed.

15. A non-transitory computer readable storage medium storing a program for causing a computer to perform an information processing method comprising:
obtaining a plurality of character strings included in data;
receiving an input of a character from a user;
displaying, on a display unit, one or more character strings corresponding to the input character among the plurality of character strings; and
setting a character string to be saved in association with a file generated based on the data, by using a character string selected by the user from the one or more character strings displayed.
